(19) United States
(12) Patent Application Publication
(10) Pub. No.: US 2017/0031219 A1
(43) Pub. Date: Feb. 2, 2017

(54) LIQUID-CRYSTAL PIXEL UNIT

(71) Applicant: AU OPTRONICS CORPORATION, Hsin-chu (TW)

(72) Inventors: Chih-Lung Lin, Hsin-chu (TW); Jian-Shen Yu, Hsin-chu (TW); Chia-En Wu, Hsin-chu (TW); Chia-Che Hung, Hsin-chu (TW)

(21) Appl. No.: 15/083,862

(22) Filed: Mar. 29, 2016

(30) Foreign Application Priority Data
Jul. 31, 2015 (TW) 104125014

(51) Int. Cl. G02F 1/1362; G02F 1/1368

(52) U.S. Cl. CPC G02F 1/136213; G02F 1/1368

(57) ABSTRACT

A liquid-crystal pixel unit includes a storage capacitor, a liquid-crystal capacitor, a data writing circuit, and a source-follower type output circuit. The storage capacitor includes a first electrode and a second electrode. The second electrode is configured to receive a first reference voltage. The liquid-crystal capacitor includes a third electrode and a fourth electrode. The fourth electrode is configured to receive a second reference voltage. The data writing circuit is electrically connected to the first electrode and the third electrode. The data writing circuit is controlled by a control signal to charge a data voltage into the storage capacitor and the liquid-crystal capacitor. The source-follower type output circuit includes an input terminal and an output terminal. The input terminal is electrically connected to the first electrode. The output terminal is electrically connected to the third electrode.

### CROSS-REFERENCE TO RELATED APPLICATIONS

This application claims the priority to and the benefit of, pursuant to 35 U.S.C. §119(a), Taiwanese Patent Application No. 104125014, filed Jul. 31, 2015, the content of which is incorporated herein in its entirety by reference.

### TECHNICAL FIELD

The instant disclosure relates generally to a liquid-crystal pixel unit, and particularly to a liquid-crystal pixel unit for maintaining the voltage of the liquid-crystal and application of the same.

### BACKGROUND

With the progress of technology, display manufacturers not only have developed liquid-crystal display devices with liquid-crystal elements, light-emitting devices with self-luminous elements, and field emission displays (FED), but also increasingly pay attention to factors related to display quality of liquid-crystal display devices, such as resolution, contrast ratio, viewing angle, gray scale inversion and color saturation. In addition, the response time of the liquid-crystal display device is also one of the research topics that display manufacturers strive to get involved in. The liquid-crystal modules with fast response time, at present, include Ferroelectric Liquid-Crystal (FLC) modules, Optical Compensated Birefringence (OCB) modules, and Blue Phase Liquid-Crystal (BPLC) modules.

However, BPLC, FLC and other liquid-crystal modules with fast response time have a reaction speed faster than that of a traditional liquid-crystal module by more than 10 times. These liquid-crystal modules with fast response time and other kinds of liquid-crystal modules have dielectric constants which change according to the frequency of charging and discharging. Due to the characteristics of changing dielectric constant, the voltage of the liquid-crystal capacitor of the liquid-crystal module may be inaccurate and thus will not be consistent with data signal voltage. When the voltage of the liquid-crystal capacitor is inaccurate, the grayscale values of the liquid-crystal display are incorrect, resulting in an image distortion of the liquid-crystal display.

### SUMMARY OF THE INVENTION

One aspect of the instant disclosure provides a liquid-crystal pixel unit which is used to solve the problem of inaccurate voltage of liquid-crystal capacitor due to a changing dielectric constant of the liquid-crystal.

One aspect of the instant disclosure provides a liquid-crystal pixel unit which includes a storage capacitor, a liquid-crystal capacitor, a data writing circuit, and a source follower. The storage capacitor includes a first electrode and a second electrode, and the second electrode is configured to receive a first reference voltage. The liquid-crystal capacitor includes a third electrode and a fourth electrode, and the fourth electrode is configured to receive a second reference voltage. The data writing circuit is electrically connected to the first electrode and the third electrode. The data writing circuit is controlled by a control signal to charge a data voltage into the storage capacitor and the liquid-crystal capacitor. The source follower includes an input terminal and an output terminal. The input terminal is electrically connected to the first electrode. The output terminal is electrically connected to the third electrode.

Another aspect of the instant disclosure provides a liquid-crystal display device, which includes a pixel matrix defining a plurality of liquid-crystal pixel units. Each of the liquid-crystal pixel unit includes a storage capacitor, a liquid-crystal capacitor, a data writing circuit, and a source follower. The storage capacitor includes a first electrode and a second electrode, and the second electrode is configured to receive a first reference voltage. The liquid-crystal capacitor includes a third electrode and a fourth electrode, and the fourth electrode is configured to receive a second reference voltage. The data writing circuit is electrically connected to the first electrode and the third electrode. The data writing circuit is controlled by a control signal to charge a data voltage into the storage capacitor and the liquid-crystal capacitor. The source follower includes an input terminal and an output terminal. The input terminal is electrically connected to the first electrode. The output terminal is electrically connected to the third electrode.

A further aspect of the instant disclosure provides a pixel matrix defining a plurality of liquid-crystal pixel units. Each of the liquid-crystal pixel unit includes a storage capacitor, a liquid-crystal capacitor, a data writing circuit, and a source follower. The storage capacitor includes a first electrode and a second electrode, and the second electrode is configured to receive a first reference voltage. The liquid-crystal capacitor includes a third electrode and a fourth electrode, and the fourth electrode is configured to receive a second reference voltage. The data writing circuit is electrically connected to the first electrode and the third electrode. The data writing circuit is controlled by a control signal to charge a data voltage into the storage capacitor and the liquid-crystal capacitor. The source follower includes an input terminal and an output terminal. The input terminal is electrically connected to the first electrode. The output terminal is electrically connected to the third electrode.

According to the liquid-crystal pixel unit, the liquid-crystal display device and the pixel matrix disclosed in the aspects of the abovementioned instant disclosure, by disposing the source follower between the first electrode of the storage capacitor and the third electrode of the liquid-crystal capacitor to compensate for voltage error of the liquid-crystal capacitor caused by the changing capacitance occurred when the frequency of charging and discharging changes, the voltage value of the liquid-crystal capacitor may be unaffected by the frequency of charging and discharging and be latched within a certain range, thereby solving the problem of inaccurate voltage of the liquid-crystal capacitor.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a schematic diagram of a circuit of the liquid-crystal pixel unit in accordance with an embodiment of the instant disclosure.

FIG. 2 illustrates a voltage timing diagram of the liquid-crystal pixel unit as shown in FIG. 1 in accordance with an embodiment of the instant disclosure.

FIG. 3 illustrates a schematic diagram of a first current path of the liquid-crystal pixel unit as shown in FIG. 1 in accordance with an embodiment of the instant disclosure.

FIG. 4 illustrates a voltage timing diagram of the liquid-crystal pixel unit as shown in FIG. 1 in accordance with another embodiment of the instant disclosure.

FIG. 5 illustrates a schematic diagram of a second current path of the liquid-crystal pixel unit as shown in FIG. 1 in accordance with another embodiment of the instant disclosure.

FIG. 6 is a schematic diagram of a circuit of the liquid-crystal pixel unit in accordance with another embodiment of the instant disclosure.

FIG. 7 is a schematic diagram of a circuit of the liquid-crystal pixel unit in accordance with a further embodiment of the instant disclosure.

### DETAILED DESCRIPTION OF THE DISCLOSURE

The present disclosure will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top”, and “left” and “right”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper”, depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

The following detailed description describes in detail the characteristics and advantages of the instant disclosure, whose content is sufficient to enable any person skilled in the relevant art to understand the technical content of the instant disclosure and implement accordingly, and according to the content, the claims and figures disclosed by the present specification, any person skilled in the relevant art can easily understand the purpose and advantages of the instant disclosure. The following embodiments further illustrate the aspects of the instant disclosure, but do not limit the scope of the instant disclosure with any aspects.

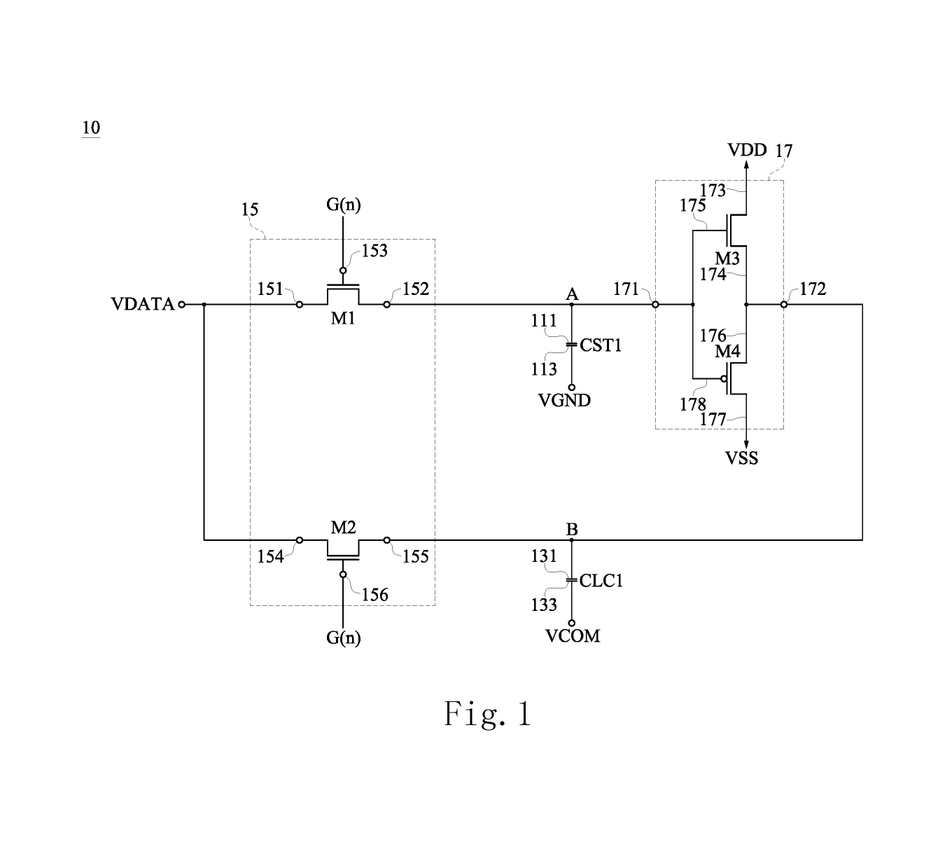

FIG. 1 is a schematic diagram of the liquid-crystal pixel unit in accordance with an embodiment of the instant disclosure. As shown in FIG. 1, the liquid-crystal pixel unit 10 includes a storage capacitor CST1, a liquid-crystal capacitor CLC1, a data writing circuit 15 and a source follower 17. The storage capacitor CST1 includes a first electrode 111 and a second electrode 113. The second electrode 113 is configured to receive a first reference voltage VGND, and the first reference voltage VGND is in a direct-current level. The liquid-crystal capacitor CLC1 includes a third electrode 131 and a fourth electrode 133. The fourth electrode 133 is configured to receive a second reference voltage VCOM. In certain embodiments, the voltage level of the second reference voltage VCOM may be substantially greater or equal to the voltage level of the first reference voltage VGND. The data writing circuit 15 is electrically connected to the first electrode 111 and the third electrode 131. The data writing circuit 15 is controlled by a control signal G(n) to charge the data voltage VDATA into the storage capacitor CST1 and the liquid-crystal capacitor CLC1. The source follower 17 includes an input terminal 171 and an output terminal 172. The input terminal 171 is electrically connected to the first electrode 111. The output terminal 172 is electrically connected to the third electrode 131.

In one embodiment, the data writing circuit 15 includes a first transistor switch M1 and a second transistor switch M2. The first transistor switch M1 includes a first end 151, a second end 152 and a first control end 153. The first end 151 is configured to receive the data voltage VDATA. The second end 152 is electrically connected to the first electrode 111 of the storage capacitor CST1. The first control end 153 is configured to receive the control signal G(n) to determine whether the first end 151 and the second end 152 of the first transistor switch M1 are in conduction with each other. The second transistor switch M2 includes a third end 154, a fourth end 155 and a second control end 156. The third end 154 is configured to receive the data voltage VDATA. The fourth end 155 is electrically connected to the third electrode 131 of the liquid-crystal capacitor CLC1. The second control end 156 is configured to receive the control signal G(n) to determine whether the third end 154 and the fourth end 155 of the first transistor switch M2 are in conduction with each other. It can be seen from the above, the second control end 156 of the second transistor switch M2 and the first control end 153 of the first transistor switch M1 receive the control signal G(n) from the same control signal source, and the first end 151 of the first transistor switch M1 and the third end 154 of the second transistor switch M2 receive the data voltage VDATA from the same data voltage source.

The source follower 17 includes a third transistor switch M3 and a fourth transistor switch M4. The third transistor switch M3 includes a fifth end 173, a sixth end 174 and a third control end 175. The fourth transistor switch M4 includes a seventh end 176, an eighth end 177 and a fourth control end 178. The fifth end 173 of the third transistor switch M3 is configured to receive the first supply voltage VDD. The third control end 175 of the third transistor switch M3 is electrically connected to the fourth control end 178 of the fourth transistor switch M4 to serve as an input terminal 171 of the source follower 17, and is electrically connected to the first electrode 111 of the storage capacitor CST1. The sixth end 174 of the third transistor switch M3 is electrically connected to the seventh end 176 of the fourth transistor switch M4 to serve as an output terminal 172 of the source follower 17, and is electrically connected to the third electrode 131 of the liquid-crystal capacitor CLC1. In addition, the eighth end 177 of the fourth transistor switch M4 is configured to receive the second supply voltage VSS. The first supply voltage VDD may be greater than the second supply voltage VSS to keep the third transistor switch M3 and the fourth transistor switch M4 operating in a saturation state.

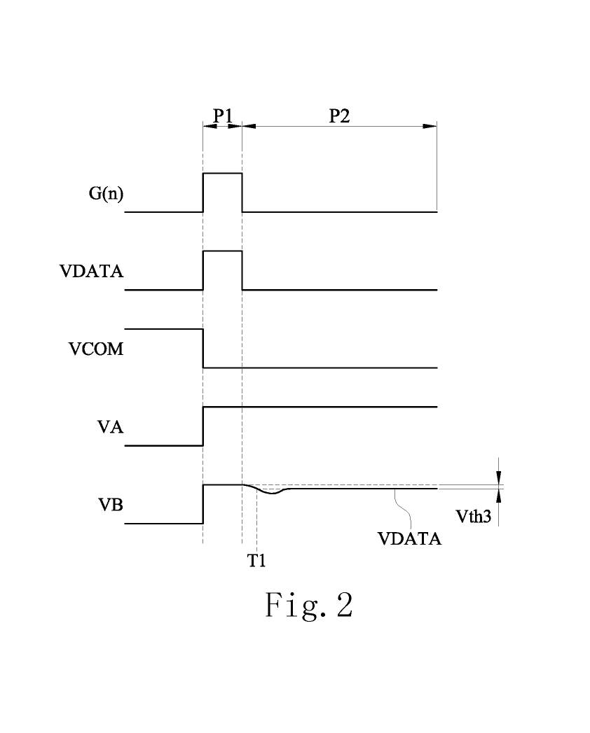

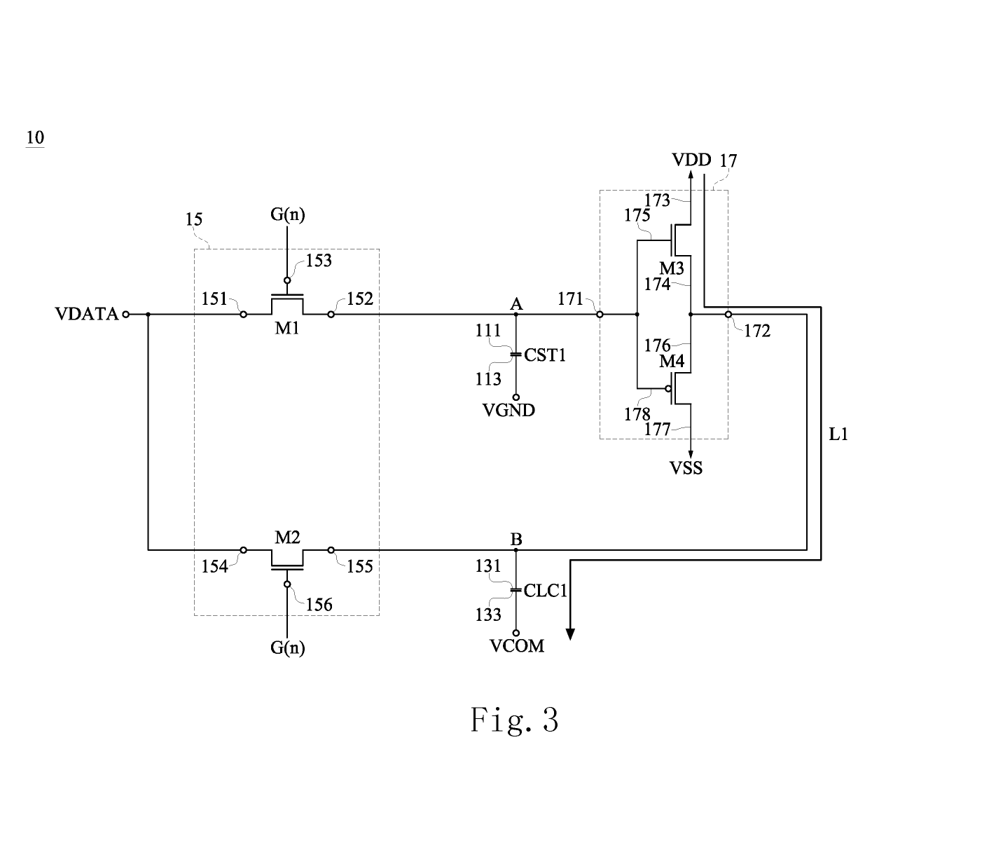

In order to illustrate the operating of the liquid-crystal pixel unit 10, please refer to FIGS. 1-3 together. FIG. 2 illustrates a voltage timing diagram of the liquid-crystal pixel unit as shown in FIG. 1 in accordance with another embodiment of the instant disclosure. FIG. 3 illustrates a schematic diagram of the first current path of the liquid-crystal pixel unit as shown in FIG. 1 in accordance with another embodiment of the instant disclosure. As shown in the figures, in the first time interval P1, the voltage level of the control signal G(n) rises, the first end 151 of the first transistor switch M1 is in conduction with the second end 152, and the data voltage VDATA is charged into the storage capacitor CST1 through the first transistor switch M1 to drive the voltage VA of the node A up to the voltage level of the data voltage VDATA. Similarly, the third end 154 of the second transistor switch M2 is in conduction with the fourth end 155, and the data voltage VDATA is charged into the liquid-crystal capacitor CLC1 through the second transistor switch M2 to drive the voltage VB of the node B up to the voltage level of the data voltage VDATA. In other words, the first time interval P1 is the voltage input stage, and in the voltage input stage, the data writing circuit 15 inputs the data voltage VDATA into the first electrode 111 of the storage capacitor CST1 and the third electrode 131 of the liquid-crystal capacitor CLC1, making the liquid-crystals of the liquid-crystal layer disposed between the third electrode 131 and the fourth electrode 133 of the liquid-crystal capacitor CLC1 rotate, thereby allowing the liquid-crystal grating to create corresponding transparency. The material of the liquid-crystal layer may be blue phase liquid-crystals, ferroelectric liquid-crystals or other suitable materials, and is not limited by the present embodiment. In one embodiment, the dielectric constant of the liquid-crystal layer is associated with the frequency of the electrical signal applied to the liquid-crystal capacitor CLC1. For the present embodiment, since the on time of the control signal G(n) is short, the liquid-crystal capacitor CLC1 is practically being charged with a high-frequency electrical signal. The range of the high-frequency electrical signal of the present embodiment is about 240 hertz (Hz). Therefore, in the first time interval P1, the liquid-crystal capacitor CLC1 has a first capacitance when the liquid-crystal capacitor CLC1 is charged with the high-frequency data voltage VDATA.

In the second time interval P2, the voltage level of the control signal G(n) decreases, the first transistor switch M1 and the second transistor switch M2 are not in conduction, and the storage capacitor CST1 and the liquid-crystal capacitor CLC1 are no longer charged with the high-frequency data voltage VDATA. At this time, the liquid-crystal capacitor CLC1 is not being charged with a high frequency electrical signal, but maintained at the voltage level of the data voltage VDATA with small changes, and the liquid-crystal capacitor CLC1 is practically being charged with a low-frequency electrical signal. Therefore, in the second time interval P2, the liquid-crystal capacitor CLC1 has a second capacitance, and the second capacitance is substantially greater than the first capacitance. In other words, the equivalent capacitance of the liquid-crystal capacitor CLC1 returns to the equivalent capacitance before the first time interval P1. At this time, the potential difference between the third electrode 131 and the fourth electrode 133 of the liquid-crystal capacitor CLC1 declines, thereby decreasing the voltage VB at the node B. When the voltage VB at the node B decreases to a level whose potential difference with the node A is greater than a threshold voltage Vth3 of the third transistor switch M3, starting from the first time point T1 shown in FIG. 2, the third transistor switch M3 turns on, and the liquid-crystal capacitor CLC1 is charged with the first supply voltage VDD received by the fifth end of the third transistor switch M3 through the first current path L1, as shown in FIG. 3, until the voltage level at the node B increases to a level whose potential difference with the node A is equal to the threshold voltage Vth3 of the third transistor switch M3. At this time, the third transistor switch M3 is turned off and the first supply voltage VDD is not charged into the liquid-crystal capacitor CLC1 through the first current path L1. In certain embodiments, the range of the high-frequency electrical signal in the present embodiment is about 240 hertz (Hz), and the range of the low-frequency electrical signal is between about 60 and 120 hertz (Hz).

Specifically, the equivalent capacitance of the liquid-crystal capacitor CLC1 in the second time interval P2 is substantially greater than the equivalent capacitance of the same in the first time interval P1. The liquid-crystal capacitor CLC1 having a substantially smaller equivalent capacitance is charged with the data voltage VDATA in the first time interval P1. When the equivalent capacitance of the liquid-crystal capacitor CLC1 increases in the second time interval P2, given that the electric charges stored in the liquid-crystal capacitor CLC1 remain unchanged, the potential difference between the first electrode 131 and the second electrode 133 of the liquid-crystal capacitor CLC1 decreases. In the present embodiment, since the fourth electrode 133 of the liquid-crystal capacitor CLC1 receives the second reference voltage VCOM of a voltage level lower than the data voltage VDATA, the liquid-crystal capacitor CLC1 is in positive polarity. Therefore, the potential difference between the first electrode 131 and the second electrode 133 of the liquid-crystal capacitor CLC1 decreases, and given that the second reference voltage VCOM remains unchanged, the voltage VB at the node B decreases, thus having a potential difference between the node A and the node B.

On the other hand, the input terminal 171 of the source follower 17 is equipotential to the node A, and the output terminal 172 of the source follower 17 is equipotential to the node B. Since there is a potential difference between the node A and node B, there is a potential difference between the input terminal 171 and the output terminal 172 of the source follower 17. The voltage level of the input terminal 171 is higher than the voltage level of the output terminal 172, such that the third transistor switch M3 of the source follower 17 is on and the first supply voltage VDD is charged into the liquid-crystal capacitor CLC1 until the potential difference between the input terminal 171 and the output terminal 172 is smaller than the threshold voltage Vth3 of the third transistor switch M3.

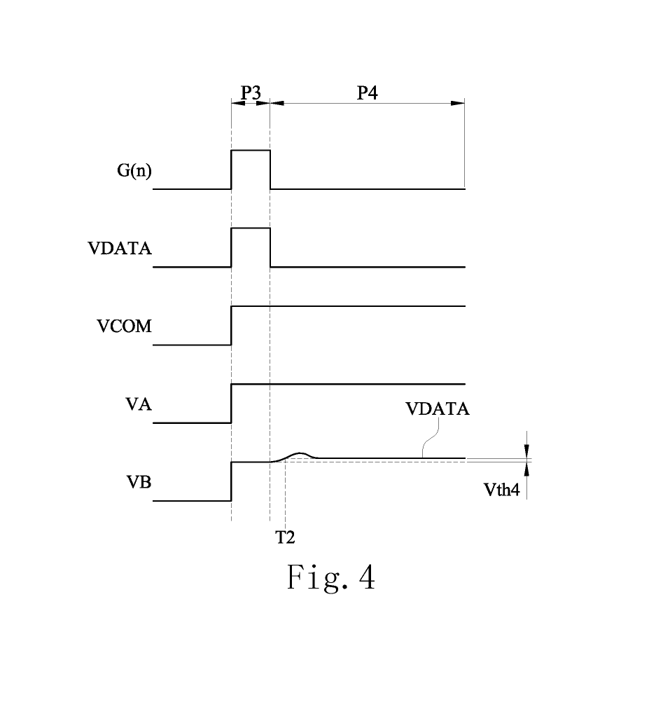

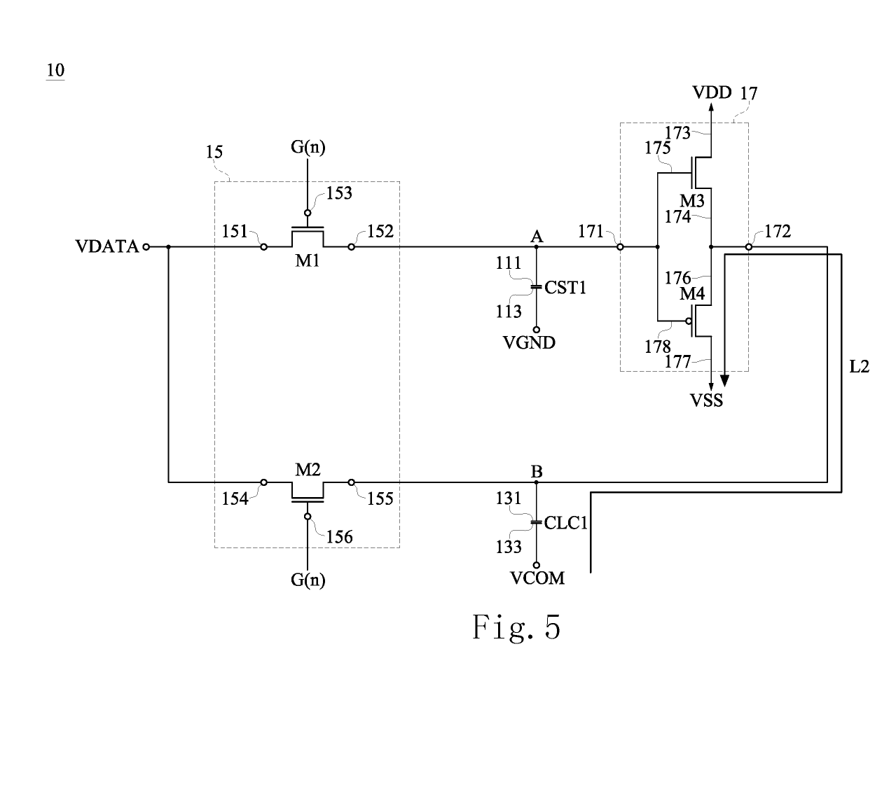

In another voltage timing diagram, please refer to FIGS. 1, 4 and 5 together. FIG. 4 illustrates a voltage timing diagram of the liquid-crystal pixel unit as shown in FIG. 1 in accordance with another embodiment of the instant disclosure, and FIG. 5 illustrates a schematic diagram of the second current path of the liquid-crystal pixel unit as shown in FIG. 1 in accordance with another embodiment of the instant disclosure. As shown in the figures, the third time interval P3 is similar to the first time interval P1 as shown in FIG. 2. In the third time interval P3, the voltage level of the control signal G(n) rises, and the data voltage VDATA is charged into the storage capacitor CST1 and the liquid-crystal capacitor CLC1 through the first transistor switch M1 and the second transistor switch M2, respectively, such that the equivalent capacitance of the liquid-crystal capacitor CLC1 is lowered and the voltage VA of the node A and voltage VB of the node B increases to the voltage level of the data voltage VDATA.

In the fourth time interval P4, the voltage level of the control signal G(n) decreases, and the first transistor switch M1 and the second transistor switch M2 are not in conduction. Thus, the storage capacitor CST1 and the liquid-crystal capacitor CLC1 are no longer charged with the high-frequency data voltage VDATA, and the equivalent capacitance of the liquid-crystal capacitor CLC1 returns to its previous level. While the electric charges stored in the liquid-crystal capacitor CLC1 remain unchanged, the potential difference between the first electrode 131 and the second electrode 133 of the liquid-crystal capacitor CLC1 decreases. In the present embodiment, since the fourth electrode 133 of the liquid-crystal capacitor CLC1 receives the second reference voltage VCOM of a voltage level higher than the data voltage VDATA, the liquid-crystal capacitor CLC1 is in negative polarity. Therefore, when the potential difference between the first electrode 131 and the second electrode 133 of the liquid-crystal capacitor CLC1 decreases, the voltage VB of the node B increases, causing a potential difference between the node A and node B, and the voltage level of the node B is higher than the voltage level of the node A, such that the fourth transistor switch M4 of the source follower 17 is on, and the liquid-crystal capacitor CLC1 starts to discharge through the second current path L2, until the voltage level of the node B is essentially equivalent to the voltage level of the node A, the fourth transistor switch is turned off and the liquid-crystal capacitor CLC1 stops discharging through the second current path L2, as shown in FIG. 5.

In practice, when the potential difference between the node A and node B is greater than the threshold voltage Vth4 of the fourth transistor switch M4, starting from the second time point T2 shown in FIG. 4, the fourth transistor switch M4 is turned on, such that the liquid-crystal capacitor CLC1 starts to discharge and the voltage level of the node B starts to decrease. When the potential difference between the node A and node B is smaller than the threshold voltage Vth4 of the fourth transistor switch M4, the fourth transistor switch M4 is turned off and the liquid-crystal capacitor CLC1 stops discharging. As shown in the voltage timing diagrams in FIGS. 2 and 4, the voltage level of the liquid-crystal capacitor CLC1 is latched in a range between the data voltage VDATA minus the threshold voltage Vth3 of the third transistor switch M3 and the data voltage VDATA plus the threshold voltage Vth4 of the fourth transistor switch M4, to solve the problem of the error data voltage VDATA charged in the liquid-crystal capacitor CLC1 due to the capacitance of the liquid-crystal capacitor CLC1 varying with the operating frequency, so as to enhance the stability of the liquid-crystal pixel drive circuit.

In one embodiment, the channel lengths of the plurality of transistor switches in the data writing circuit 15 are substantially smaller than the channel lengths of the plurality of transistor switches in the source follower 17. In other words, the channel lengths of the first transistor switch M1 and the second transistor switch M2 are substantially smaller than the channel lengths of the third transistor switch M3 and the fourth transistor switch M4. Therefore, the threshold voltage Vth3 of the third transistor switch M3 and the threshold voltage Vth4 of the fourth transistor switch M4 are relatively small, allowing the voltage level of the liquid-crystal capacitor CLC1 to be latched within a limited range. In other alternative embodiments, the width-to-length ratios (W/L ratio) of the channels of the plurality of transistor switches in the data writing circuit 15 may be designed to be substantially greater than the W/L ratios of the channels of the plurality of transistor switches in the source follower 17, but the present embodiment is not limited thereto. The channel length defined in the instant disclosure is associated with the electron current flowing in the transistor switch from a source to a drain, while the channel width defined in the instant disclosure is associated with the amount of electrons in the transistor switch provided by the area of the source.

In addition, in one embodiment, the capacitance of the storage capacitor CST1 is substantially smaller than the capacitance of the liquid-crystal capacitor CLC1. This is due to, for example, the storage capacitor CST1 being used to drive the voltage level of the node A up to the voltage level of the data voltage VDATA and make the voltage level of the node A to have small changes. Further, by disposing the source follower 17 between the storage capacitor CST1 and the liquid-crystal capacitor CLC1, the storage capacitor CST1 and the liquid-crystal capacitor CLC1 are not easily affected by each other. Therefore, the capacitance of the storage capacitor CST1 may be substantially smaller than the capacitance of the liquid-crystal capacitor CLC1, and the area occupied by the storage capacitor CST1 may also be substantially smaller, increasing an aperture ratio of the display.

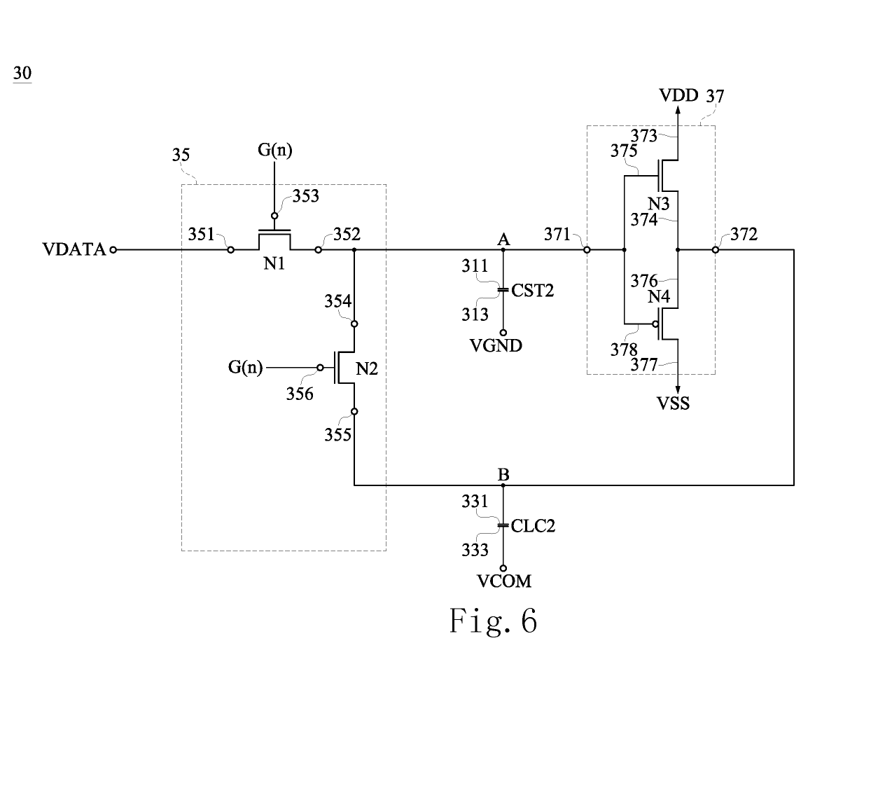

Please refer to FIG. 6. FIG. 6 is a schematic diagram of a circuit of the liquid-crystal pixel unit in accordance with another embodiment of the instant disclosure. As shown in FIG. 6, the liquid-crystal pixel unit 30 includes a storage capacitor CST2, a liquid-crystal capacitor CLC2, a data writing circuit 35 and a source follower 37. The storage capacitor CST2 includes a first electrode 311 and a second electrode 313. The second electrode 313 is configured to receive a first reference voltage VGND, and the first reference voltage VGND is in a direct-current level. The liquid-crystal capacitor CLC2 includes a third electrode 331 and a fourth electrode 333, and the fourth electrode 333 is configured to receive a second reference voltage VCOM.

The data writing circuit 35 includes a first transistor switch N1 and a second transistor switch N2. The first transistor switch N1 includes a first end 351, a second end 352 and a first control end 353. The first end 351 of the transistor switch N1 is configured to receive the data voltage VDATA. The second end 352 is electrically connected to the first electrode 311 of the storage capacitor CST2. The first control end 353 is configured to receive the control signal G(n) to determine whether the first end 351 and the second end 352 of the first transistor switch N1 are in conduction with each other. The second transistor switch N2 includes a third end 354, a fourth end 355 and a second control end 356. The third end 354 is electrically connected to the first electrode 311 of the storage capacitor CST2 and the second end 352 of the first transistor switch N1 to receive the data voltage VDATA when the first transistor switch N1 is turned on. The fourth end 355 of the second transistor switch N2 is electrically connected to the third electrode 331 of the liquid-crystal capacitor CLC2. The second control end 356 is configured to receive the control signal G(n) to determine whether the third end 354 and the fourth end 355 of the second transistor switch N2 are in conduction with each other. As disclosed above, the second control end 356 of the second transistor switch N2 and the first control end 353 of the first transistor switch N1 receive the control signal G(n) from the same control signal source. In the present embodiment, the first transistor switch N1, the second transistor switch N2 and the third transistor switch N3 are N-type transistor switches, and the fourth transistor switch N4 is a P-type transistor switch.

The source follower 37 includes an input terminal 371 and an output terminal 372. The input terminal 371 is electrically connected to the first electrode 311 of the storage capacitor CST2. The output terminal 372 is electrically connected to the third electrode 331 of the liquid-crystal capacitor CLC2. In the present embodiment, for the operating of the liquid-crystal pixel unit 30, one may refer to the operating of the liquid-crystal pixel unit 10 in the previous embodiment and the timing diagram shown in FIGS. 2 and 4, and thus no further descriptions will be provided here.

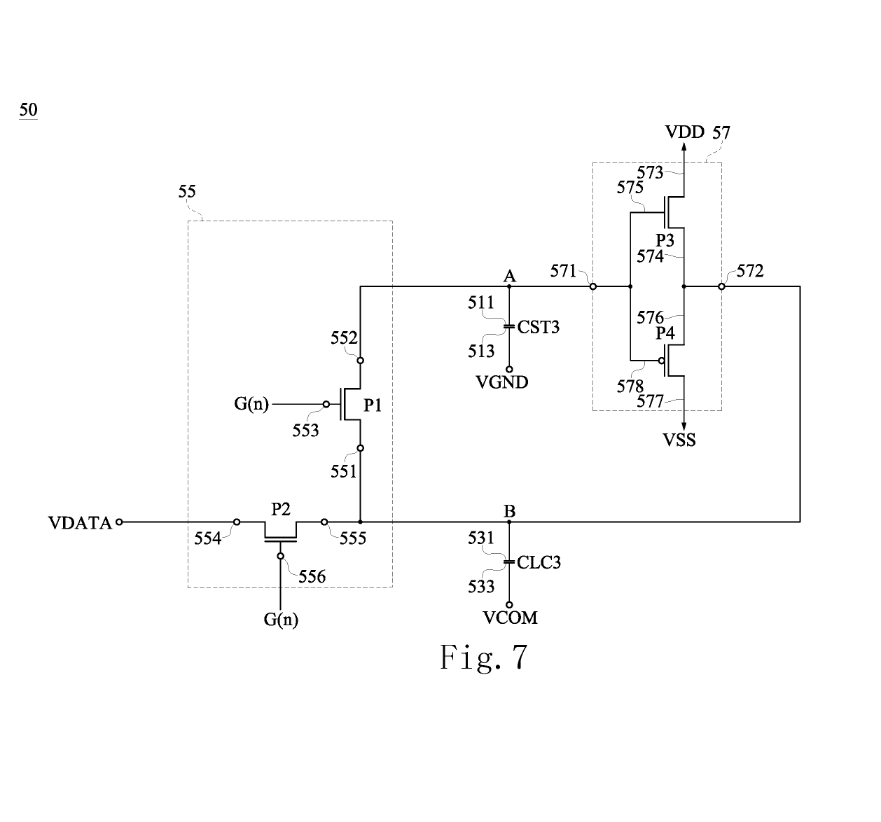

Please refer to FIG. 7. FIG. 7 is a schematic diagram of a circuit of the liquid-crystal pixel unit in accordance with a further embodiment of the instant disclosure. As shown in FIG. 7, the liquid-crystal pixel unit 5 includes a storage capacitor CST3, a liquid-crystal capacitor CLC3, a data writing circuit 55 and a source follower 57. The storage capacitor CST3, the liquid-crystal capacitor CLC3, and the source-follower 57 are approximately similar to the storage capacitor CST2, the liquid-crystal capacitor CLC2, and the source follower 37 in FIG. 6, respectively, and are not further described here. The difference of the circuit in this embodiment from the circuit in the embodiment as shown in FIG. 6 is the data writing circuit 55, which includes a first transistor switch P1 and a second transistor switch P2. The first transistor switch P1 includes a first end 551, a second end 552 and a first control end 553. The first end 551 of the first transistor switch P1 is electrically connected to the third electrode 531 of the liquid-crystal capacitor CST3 to receive the data voltage VDATA when the second transistor switch P2 is turned on. The second end 552 of the first transistor switch P1 is electrically connected to the first electrode 511 of the storage capacitor CST3. The first control end 553 is configured to receive the control signal G(n) to determine whether the first end 551 and the second end 552 of the first transistor switch P1 are in conduction with each other. The second transistor switch P2 includes a third end 554, a fourth end 555 and a second control end 556. The third end 554 of the second transistor switch P2 is configured to receive the data voltage VDATA. The fourth end 555 of the second transistor switch P2 is electrically connected to the third electrode 531 of the liquid-crystal capacitor CLC3 and the first end 551 of the first transistor switch P1. The second control end 556 is configured to receive the control signal G(n) to determine whether the third end 554 and the fourth end 555 of the second transistor switch P2 are in conduction with each other. As disclosed above, the second control end 556 of the second transistor switch P2 and the first control end 553 of the first transistor switch P1 receive the control signal G(n) from the same control signal source. In the present embodiment, the first transistor switch P1, the second transistor switch P2 and the third transistor switch P3 are N-type transistor switches, and the fourth transistor switch P4 is a P-type transistor switch.

In certain embodiments, the liquid-crystal pixel unit as disclosed above may be used in a pixel matrix, which defines a plurality of liquid-crystal pixel units, where each of the liquid-crystal pixel units has the structures as disclosed above. Further, in certain embodiments, the liquid-crystal pixel unit as disclosed above may be used in a liquid-crystal display device, which includes a pixel matrix defining a plurality of liquid-crystal pixel units, where each of the liquid-crystal pixel units has the structures as disclosed above.

In summary, the liquid-crystal pixel unit of the instant disclosure, by disposing the source follower between the first electrode and the second electrode of the storage capacitor to compensate for voltage error of the liquid-crystal capacitor caused by the changing capacitance occurred when the frequency of charging and discharging changes, allows the voltage of the liquid-crystal capacitor to be unaffected by the frequency of charging and discharging and be latched within a certain range, thereby solving the problem of inaccurate voltage of the liquid-crystal capacitor.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A liquid-crystal pixel unit, comprising:
a storage capacitor having a first electrode and a second electrode, the second electrode being configured to receive a first reference voltage;
a liquid-crystal capacitor having a third electrode and a fourth electrode, the fourth electrode being configured to receive a second reference voltage;
a data writing circuit electrically connected to the first electrode and the third electrode and controlled by a control signal to charge a data voltage into the liquid-crystal capacitor and the storage capacitor; and
a source follower having an input terminal and an output terminal, the input terminal being electrically connected to the first electrode and the output terminal being electrically connected to the third electrode.

2. The liquid-crystal pixel unit according to claim 1, wherein the data writing circuit comprises:
a first transistor switch having a first end, a second end and a first control end, the first end being configured to receive the data voltage, the second end being electrically connected to the first electrode, the first control end being configured to receive the control signal to determine whether the first end and the second end are in conduction with each other; and
a second transistor switch having a third end, a fourth end and a second control end, the third end being configured to receive the data voltage, the fourth end being electrically connected to the third electrode, the second control end being configured to receive the control signal to determine whether the third end and the fourth end are in conduction with each other.

3. The liquid-crystal pixel unit according to claim 1, wherein the data writing circuit comprises:
a first transistor switch having a first end, a second end and a first control end, the first end being configured to receive the data voltage, the second end being electrically connected to the first electrode, the first control end being configured to receive the control signal to determine whether the first end and the second end are in conduction with each other; and
a second transistor switch having a third end, a fourth end and a second control end, the third end being electrically connected to the first electrode, the fourth end being electrically connected to the third electrode, the second control end being configured to receive the control signal to determine whether the third end and the fourth end are in conduction with each other.

4. The liquid-crystal pixel unit according to claim 1, wherein the data writing circuit comprises:
a first transistor switch having a first end, a second end and a first control end, the first end being electrically connected to the third electrode, the second end being electrically connected to the first electrode, the first control end being configured to receive the control signal to determine whether the first end and the second end are in conduction with each other; and
a second transistor switch having a third end, a fourth end and a second control end, the third end being configured to receive the data voltage, the fourth end being electrically connected to the third electrode, the second control end being configured to receive the control signal to determine whether the third end and the fourth end are in conduction with each other.

5. The liquid-crystal pixel unit according to claim 1, wherein the liquid-crystal capacitor further has a liquid-crystal layer disposed between the third electrode and the fourth electrode.

6. The liquid-crystal pixel unit according to claim 5, wherein a dielectric constant of the liquid-crystal layer is associated with a frequency of the electrical signal applied to the liquid-crystal capacitor.

7. The liquid-crystal pixel unit according to claim 6, wherein a material of the liquid-crystal layer is blue phase liquid-crystal (BPLC).

8. The liquid-crystal pixel unit according to claim 1, wherein channel lengths of a plurality of transistor switches in the data writing circuit are substantially smaller than channel lengths of a plurality of transistor switches in the source follower.

9. The liquid-crystal pixel unit according to claim 1, wherein width-to-length (W/L) ratios of channels of a plurality of transistor switches in the data writing circuit are substantially greater than W/L ratios of channels of a plurality of transistor switches in the source follower.

10. The liquid-crystal pixel unit according to claim 1, wherein a capacitance of the storage capacitor is substantially smaller than a capacitance of the liquid-crystal capacitor.

11. The liquid-crystal pixel unit according to claim 1, wherein the source follower comprises:
a third transistor switch having a fifth end, a sixth end and a third control end, the fifth end being configured to receive a first supply voltage; and
a fourth transistor switch having a seventh end, an eighth end and a fourth control end, the seventh end being electrically connected to the sixth end of the third transistor to serve as the output terminal, the eighth end being configured to receive a second supply voltage, the fourth control end being electrically connected to the third control end of the third transistor switch to server as the input terminal.

12. A liquid-crystal display device, comprising:
a pixel matrix defining a plurality of liquid-crystal pixel units, wherein each of the liquid-crystal pixel units comprises:
a storage capacitor having a first electrode and a second electrode, the second electrode being configured to receive a first reference voltage;
a liquid-crystal capacitor having a third electrode and a fourth electrode, the fourth electrode being configured to receive a second reference voltage;
a data writing circuit electrically connected to the first electrode and the third electrode and controlled by a control signal to charge a data voltage into the liquid-crystal capacitor and the storage capacitor; and
a source follower having an input terminal and an output terminal, the input terminal being electrically connected to the first electrode and the output terminal being electrically connected to the third electrode.

13. The liquid-crystal display device according to claim 12, wherein the data writing circuit comprises:
a first transistor switch having a first end, a second end and a first control end, the first end being configured to receive the data voltage, the second end being electrically connected to the first electrode, the first control end being configured to receive the control signal to determine whether the first end and the second end are in conduction with each other; and
a second transistor switch having a third end, a fourth end and a second control end, the third end being configured to receive the data voltage, the fourth end being electrically connected to the third electrode, the second control end being configured to receive the control signal to determine whether the third end and the fourth end are in conduction with each other.

14. The liquid-crystal display device according to claim 12, wherein the data writing circuit comprises:
a first transistor switch having a first end, a second end and a first control end, the first end being configured to receive the data voltage, the second end being electrically connected to the first electrode, the first control end being configured to receive the control signal to determine whether the first end and the second end are in conduction with each other; and
a second transistor switch having a third end, a fourth end and a second control end, the third end being electrically connected to the first electrode, the fourth end being electrically connected to the third electrode, the second control end being configured to receive the control signal to determine whether the third end and the fourth end are in conduction with each other.

15. The liquid-crystal display device according to claim 12, wherein the data writing circuit comprises:
a first transistor switch having a first end, a second end and a first control end, the first end being electrically connected to the third electrode, the second end being electrically connected to the first electrode, the first control end being configured to receive the control signal to determine whether the first end and the second end are in conduction with each other; and
a second transistor switch having a third end, a fourth end and a second control end, the third end being configured to receive the data voltage, the fourth end being electrically connected to the third electrode, the second control end being configured to receive the control signal to determine whether the third end and the fourth end are in conduction with each other.

16. The liquid-crystal display device according to claim 12, wherein the source follower comprises:
a third transistor switch having a fifth end, a sixth end and a third control end, the fifth end being configured to receive a first supply voltage; and
a fourth transistor switch having a seventh end, an eighth end and a fourth control end, the seventh end being electrically connected to the sixth end of the third transistor to serve as the output terminal, the eighth end being configured to receive a second supply voltage, the fourth control end being electrically connected to the third control end of the third transistor switch to server as the input terminal.

17. A pixel matrix defining a plurality of liquid-crystal pixel units, each of the liquid-crystal pixel units comprising:
a storage capacitor having a first electrode and a second electrode, the second electrode being configured to receive a first reference voltage;
a liquid-crystal capacitor having a third electrode and a fourth electrode, the fourth electrode being configured to receive a second reference voltage;
a data writing circuit electrically connected to the first electrode and the third electrode and controlled by a control signal to charge a data voltage into the liquid-crystal capacitor and the storage capacitor; and
a source follower having an input terminal and an output terminal, the input terminal being electrically connected to the first electrode and the output terminal being electrically connected to the third electrode.

18. The pixel matrix according to claim 17, wherein the data writing circuit comprises:
a first transistor switch having a first end, a second end and a first control end, the first end being configured to receive the data voltage, the second end being electrically connected to the first electrode, the first control end being configured to receive the control signal to determine whether the first end and the second end are in conduction with each other; and
a second transistor switch having a third end, a fourth end and a second control end, the third end being configured to receive the data voltage, the fourth end being electrically connected to the third electrode, the second control end being configured to receive the control signal to determine whether the third end and the fourth end are in conduction with each other.

19. The pixel matrix according to claim 17, wherein the data writing circuit comprises:
a first transistor switch having a first end, a second end and a first control end, the first end being configured to receive the data voltage, the second end being electrically connected to the first electrode, the first control end being configured to receive the control signal to determine whether the first end and the second end are in conduction with each other; and
a second transistor switch having a third end, a fourth end and a second control end, the third end being electrically connected to the first electrode, the fourth end being electrically connected to the third electrode, the second control end being configured to receive the control signal to determine whether the third end and the fourth end are in conduction with each other.

20. The pixel matrix according to claim 17, wherein the data writing circuit comprises:
a first transistor switch having a first end, a second end and a first control end, the first end being electrically connected to the third electrode, the second end being electrically connected to the first electrode, the first control end being configured to receive the control signal to determine whether the first end and the second end are in conduction with each other; and
a second transistor switch having a third end, a fourth end and a second control end, the third end being configured to receive the data voltage, the fourth end being electrically connected to the third electrode, the second control end being configured to receive the control signal to determine whether the third end and the fourth end are in conduction with each other.
